(19) United States
(12) Patent Application Publication
(10) Pub. No.: US 2021/0073697 A1
(43) Pub. Date: Mar. 11, 2021

(54) CONSOLIDATING OIL FIELD PROJECT DATA FOR PROJECT TRACKING

(71) Applicant: Schlumberger Technology Corporation, Sugar Land, TX (US)

(72) Inventors: Vishvesh Paranjape, Pune (IN); Vishakha Vijay Bhoite, Pune (IN); Jeremy Campbell, Harrogate (GB); Sayani Kumar, Pune (IN); Suresh Chaudhari, Pune (IN)

(21) Appl. No.: 16/948,087

(22) Filed: Sep. 2, 2020

Related U.S. Application Data
(60) Provisional application No. 62/899,100, filed on Sep. 11, 2019.

(51) Int. Cl. G06Q 10/06; G06Q 50/06; G06F 21/31; G06T 11/20

(52) U.S. Cl. CPC G06Q 10/06313; G06T 11/206; G06F 21/31; G06Q 50/06

(57) ABSTRACT

A method for consolidating and streaming the presentation of oilfield project data distributed across multiple sources comprises receiving multiple project data objects containing project-related data for one or more oil/gas projects in which the multiple project data objects are in different formats storing the multiple project data objects in a queue; translating the multiple project data objects into standardized formats to form translated project data objects containing the project-related data in a standardized format; generating a dashboard based on the translated project data objects; and outputting the dashboard for display to a user.

### CROSS-REFERENCE TO RELATED APPLICATIONS

This application claims priority to U.S. Provisional Patent Application 62/899,100, which was filed Sep. 11, 2019, and is incorporated herein by reference in its entirety.

### BACKGROUND

Exploration and Production (E&P) software platforms are used in the oilfield to collect and analyze a variety of technical data. This data may be used for a variety of petrotechnical applications and projects relating to, for example, locating, planning, drilling, and/or producing hydrocarbons from a well. Such E&P platforms may be collaborative, providing an environment in which teams of experts in different locations and/or different disciplines can work together to improve project success. Project management tools may be used in conjunction with E&P platforms to facilitate the completion of various petrotechnical and oil/gas exploration and recovery related tasks and milestones.

### SUMMARY

Embodiments of the disclosure may provide a method for consolidating and streaming the presentation of oilfield project data distributed across multiple sources. The method may include receiving multiple project data objects containing project-related data for one or more oil/gas projects in which the multiple project data objects are in different formats storing the multiple project data objects in a queue; translating the multiple project data objects into standardized formats to form translated project data objects containing the project-related data in a standardized format; generating a dashboard based on the translated project data objects; and outputting the dashboard for display to a user.

Embodiments of the disclosure may also provide a computing system, including one or more processors; and a memory system comprising one or more non-transitory computer-readable media storing instructions that, when executed by at least one of the one or more processors, cause the computing system to perform operations. The operations may include receiving multiple project data objects containing project-related data for one or more oil/gas projects in which the multiple project data objects are in different formats storing the multiple project data objects in a queue; translating the multiple project data objects into standardized formats to form translated project data objects containing the project-related data in a standardized format; generating a dashboard based on the translated project data objects; and outputting the dashboard for display to a user.

Embodiments of the disclosure may further provide a non-transitory computer-readable medium storing instructions that, when executed by one or more processors of a computing system, cause the computing system to perform operations. The operations may include receiving multiple project data objects containing project-related data for one or more oil/gas projects in which the multiple project data objects are in different formats storing the multiple project data objects in a queue; translating the multiple project data objects into standardized formats to form translated project data objects containing the project-related data in a standardized format; generating a dashboard based on the translated project data objects; and outputting the dashboard for display to a user.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example petrotechnical environment, according to an embodiment.

FIG. 3 illustrates a block diagram of example operations of a project tracking application server, according to an embodiment.

FIG. 4 illustrates an example flowchart of a process of a project tracking application for consolidating oil field project-related data and streamlining the presentation of the project-related data for a user, according to an embodiment.

FIGS. 5A-5C illustrate example views of project dashboards presented by the project tracker application, according to an embodiment.

FIG. 6 illustrates a schematic view of a computing system, according to an embodiment.

### DETAILED DESCRIPTION

Project management tools may be used in conjunction with E&P platforms to facilitate the completion of various petrotechnical and oil/gas exploration and recovery related tasks and milestones associated with a project. Team members in involved in oil/gas related projects may be geographically scattered, have varying skillsets, and may use different types of project management tools to manage the completion of project management tasks and milestones. Also, service providers involved in executing project-related tasks on behalf of a client may use internal project applications for tracking the status of project tasks, but these internal tools may not be accessible by external clients. The use of different types of project management tools and applications may present a technical problem for consolidating project management-related data across a team. For example, project data may be in different formats incompatible with a client's project management tools. As such, tracking a project by determining project status and other project management information may be difficult and/or time consuming to determine. Further, project management information may be inaccurate when project data is scatted across multiple different databases, originating from different project management applications, and stored in different formats.

Accordingly, aspects of the present disclosure may include a project tracking application that improves project tracking visualization by standardizing project data objects, containing project-related information, from disparate project applications and sources, and converting the standardized project data objects into data that may be presented in a visual and graphical dashboard. In this way, the presentation of project-related information may be standardized and streamlined such that an accurate representation of project status, metrics, progress, etc. may be easily viewed even when project source data is in various format and locations, and/or when project status source data originates from a service providers internal systems. Further, collaboration and communication among team members may be improved as the accurate status of projects may be easily shared and viewed among team members, thereby improving management of team member efforts. Additionally, or alternatively, project data from multiple sources may be consolidated in a single location, thereby facilitating the reporting of project data across different projects and sources. While aspects of the present disclosure described herein may be described in terms of improving the presentation of oil/gas related projects, it is noted that the techniques described herein are not so limited and may be applied to other types of projects.

As described herein, aspects of the present disclosure may include a project tracker application which may include a cloud-native application that provides users with visibility of project information across one or more projects. In some embodiments, a user may include a client and/or a team member of a service provider involved in executing tasks associated with the project. The project tracker application may aid teams of service providers to efficiently manage and execute project tasks over a project lifecycle and provide clients with a dashboard that presents project progress, budget, schedules, milestones, risk issues, etc.

In some embodiments, the project tracker application may sync data from databases that are internal to the service provider, and deliver the data in a user-friendly format within an E&P software platform. The project tracker application may further provide a dashboard that is personalized to both service provider operators and client/users. For example, the dashboard may present an internal service provider view and an external client view.

In some embodiments, the “internal view” allows a project manager within the service provider organization to be designated as a “super user” role (e.g., an administrative role) to add and remove both internal and external users, thereby controlling which users may see projects as well as edit and manage the data within those projects to show only specific information to the client. In this way, certain data may be exposed or hidden from the client view depending on sensitivity. The editing and customization of the dashboard may be implemented within the application and separately from the internal applications/databases, ensuring that data is only exposed to clients as selected by the service provider.

In some embodiments, the “client view” may provide a project summary delivering overall health of the project and details of any problem and actions that may affect project timelines. The client view may further allow users to customize the project summary page by moving and ordering “widgets” or objects within the dashboard that present project-related information, such as the overall project health, milestone progress, resource, schedule, scope, quality attributes of the project, etc. according to their preference. In some embodiments, the client view may display project schedule information, such as days elapsed, project milestones, deliverables, associated documents, percentage complete, budget tracking, project phase status information, etc. The client view of the project dashboard may also provide a list of risks and issues associated with the project.

In some embodiments, the project tracker application may be driven by source data from a service provider's internal project management application. In this way, the project tracker application may use the service provider's internal data, stored in service provider's database, to be delivered to the client in a dashboard that is intuitive and user friendly, providing increased collaboration, visibility and transparency and an enhanced customer experience.

Aspects of the present disclosure may provide a project tracker application that presents to users, both internal and external, a personalized view of projects (e.g., within an E&P software platform). In some embodiments, login credentials may be provided for accessing the E&P software platform and identifying the user for providing the user with a personalized dashboard within the project tracker application. In some embodiments, different user roles may be used with project tracker application (e.g., a “super user” or administrative user and a “standard user”). For example, the login credentials may be used to identify the user and the user's designated role. In some embodiments, the super may include a project manager and may be part of a service provider organization. The super user may assign standard users to a project to allow the assigned users to view and collaborate on a particular project and/or remove standard users from the project. In some embodiments, the super user may edit data within the project tracker application separately from the internal databases/programs, and customize the view that different standard users may see. This allows the project manager to expose or hide data depending on sensitivity or client need.

In some embodiments, standard users may be either internal or external users assigned to a project by the super user, allowing the standard users to see the project tracker dashboard for single or multiple projects to which they are assigned. In some embodiments, the normal user's functionality may be restricted from editing data but may permitted to customize various views of the dashboard. For example, a standard user may customize the “summary” view by moving and reordering “widgets” or objects within the dashboard that present project information, such as the overall health, resource, schedule, scope, quality attributes of the project, etc. In some embodiments, standard users may also customize the “project overview” by reordering/resorting projects by project name, project progress, project milestone, etc., as well as ascending/descending order.

Aspects of the present disclosure may include a system and/or method that consolidates a vast volume of project-related data from numerous locations and in numerous formats. The systems and/or methods described herein consolidate and present the project-related data in a manner that may not be practically performed without the use of computing hardware executing an unconventional combination of operations implemented by the project tracker application, as described herein. Further, aspects of the present disclosure provide a user interface that improves the speed at which project-related data is obtained and provided to a user, as well as the accuracy, and/or usability of project-related data. For example, aspects of the present disclosure leverage the use of an adapter/convertor component to standardize project-related data across multiple sources and formats, thus improving the accuracy of the project-related data when reported to the user. Further, the dashboard, described herein, provides custom and streamlined graphical views of project-related data to improve the usability of the project-related data. Additionally, the use of the adapter/convertor component vastly increases the speed at which the project-related data is gathered and presented to the user, as it is no longer necessary to manually parse through project-related data in various formats.

In some embodiments, data owners, such as project support service providers, may continue to use their internal systems to track and manage project tasks, while also providing the project-related data to stakeholders and end users. In this way, internal project data may be made available to clients without the requiring the clients to use the same internal project tracking tools as the service provider (which may be costly, require extensive training, or not permitted in the event the service provider's project tracking tools are proprietary). As such, the service provider may continue to operate as usual, while still allowing the client to view project-related data in a streamlined graphical dashboard.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

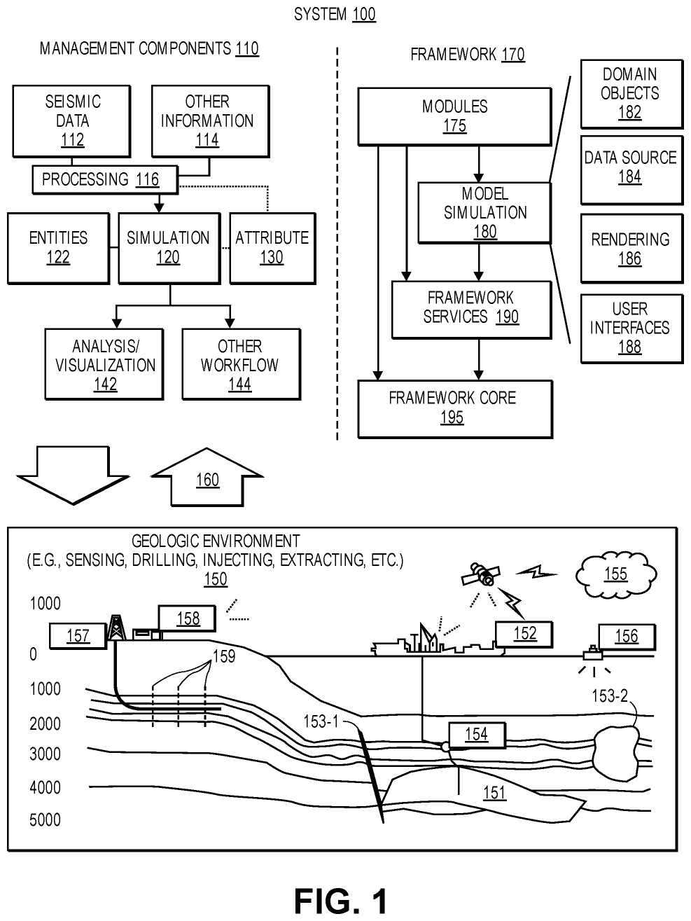

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Wash.), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

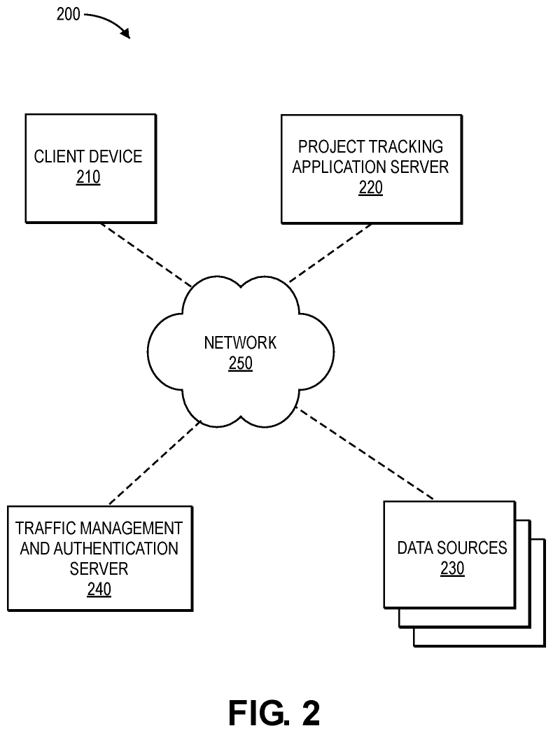

FIG. 2 illustrates an example petrotechnical environment according to an embodiment. As shown in FIG. 2, an environment 200 includes a client device 210, a data loading application server 220, data sources 230, a traffic management and authentication server 240, a data processing application server 250, and a network 260.

The client device 210 may include a computing device capable of communicating via a network, such as the network 240. In example embodiments, the client device 210 corresponds to a portable computer device (e.g., a laptop or a tablet computer), a desktop computer, a server computer and/or another type of computing device. In some embodiments, the client device 210 may be used to access a project tracking application supported and/or hosted by the project tracking application server 220 (e.g., via an application, a web portal, or the like). In some embodiments, the client device 210 may provide login credentials to identify the client and access a custom dashboard associated with the client.

The project tracking application server 220 may include one or more computing devices that host a project tracking application. More specifically, the project tracking application server 220 may execute the functions of the project tracking application, such as receiving project data objects relating to project status from one or more data sources 230, storing project data objects in a queue, translating the project data objects into a standardized format, storing the translated project data object into, converting the translated project data object into a dashboard presentation data, and outputting the dashboard presentation data for display in a dashboard (e.g., via the client device 210). In this way, the project tracking application server 220 may present (e.g., via the dashboard), project information for data in various locations and formats, such as formats internal to a service provider.

The data sources 230 may include one or more computing devices that store data objects relating to project status. In some embodiments, the data sources 230 may be internal databases of one or more service providers. Further, the data sources 230 may include data objects used by a service provider's internal project tracking systems for tracking the status of the project on an internal level. In some embodiments, the data sources 230 may store data objects in different format used by different project-related applications. As described herein, the project tracking application server 220 may obtain the data objects from the data sources 230 and standardize the data objects for presentation in a dashboard.

The traffic management and authentication server 240 may include one or more computing devices that manage access requests to the project tracking application server 220 (e.g., access requests made by the client device 210 to access the project application server for presenting a dashboard). For example, the traffic management and authentication server 240 may act as a gatekeeper when the client device 210 access the project tracking application server 220. In some embodiments, the traffic management and authentication server 240 may perform any variety of authentication and/or traffic management tasks, such as restricting access to the project tracking application server 220 by a restricted client device 210 (e.g., a client device 210 located in a restricted geographic location, a client device 210 from a restricted network, etc.). Additionally, or alternatively, the traffic management and authentication server 240 may perform authentication to permit or restrict the client device 210 from access the project tracking application server 220 (e.g., credential verification, certificate verification, hash verification, encryption/decryption-based verification, etc.).

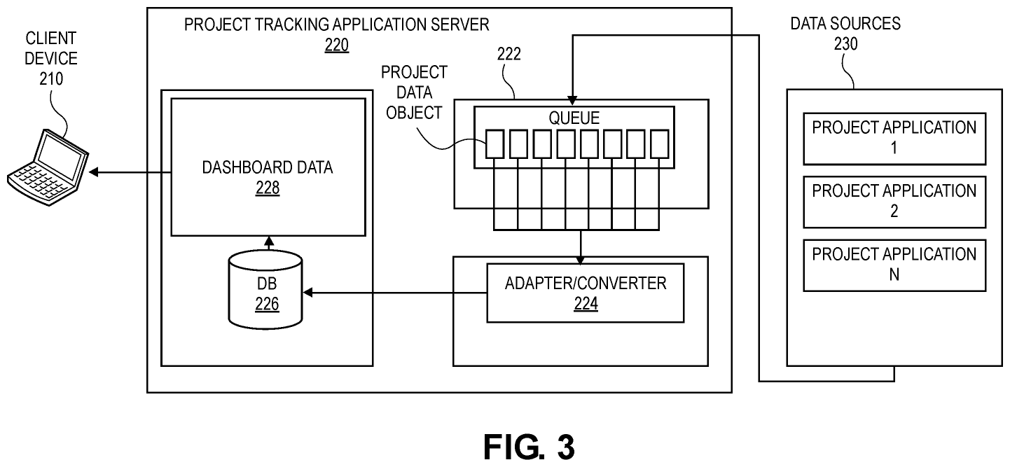

FIG. 3 illustrates a block diagram of example operations according to an embodiment. As shown in FIG. 3, data sources 230 may include project-related applications (e.g., project application 1 through project application N). The project-related applications may be used to track projects and, in some cases, may be internal project management tools or applications used by a service provider involved in executing project tasks on behalf of a client. The project-related applications may generate data objects containing project related information (e.g., project status, milestone progress, milestone phases, project risks/issues, etc.). In some embodiments, different data objects produced by different project-related applications may be in different formats.

In some embodiments, the project-related applications may include a web-enabled product or an application capable of pushing data objects using, for example, Representational State Transfer Application Programming Interfaces (REST APIs) and/or other techniques. In some embodiments, the project tracking application server 220 may obtain the project data objects from the data sources 230 and store the project data objects in a queue 222. In some embodiments, original and unmodified project data objects may be stored in the queue 222. The project tracking application server 220 may obtain the project data objects for a particular client on a push or pull basis and may implement any variety of syncing rules and/or syncing logic to obtain the data objects (e.g., on a recurring schedule, when new changes are made and new data objects are generated, etc.). In some embodiments, the project data objects may include information identifying a client, a project, and/or any variety of project-related information (e.g., project status, milestone progress, milestone phases, project risks/issues, etc.). In some embodiments, the project data objects may store information in a structured or unstructured format. The project tracking application server 220 may store the data objects in a queue 222 associated with a particular client or project.

As further shown in FIG. 3, the project data objects may be processed by an adapter/converter 224 implemented by the project tracking application server 220. For example, the adapter/converter 224 may process the data objects by translating the data objects into a standardized format (e.g., since different data objects from different project-related applications may be in different formats). More specifically, the adapter/converter 224 may analyze a data object, identify project-related information from the data object, and convert the project-related information into a standardized format. As an example, the data “Customer name” from one data object may translated to “PTName” and the data “Client name” from another data object may also be translated to “PTName.” In this way, project information may be standardized when the project information contained in different data objects is in different formats. In some embodiments, the adapter/converter 224 may include a list of definitions for different types of project-related applications and may use the list of definitions to facilitate the translation of the data objects into a standardized format. In some embodiments, REST APIs may be exposed for the adapter/convert 224 to acquire data from the queue 222.

The processed data objects (e.g., the standardized data objects) may be stored in a database (e.g., database 226). The stored standardized data objects may then be converted into dashboard data 228, which may be provided to the client device 210 for display in a dashboard. In some embodiments, converting the standardized objects into dashboard data may involve determining the manner in which the standardize objects are to be presented in the dashboard (e.g., based on the payload within the standardized data objects), and generating display instructions based on this determination. For example, standardized data objects identifying milestone status may be presented as a Gantt chart, a pie chart with a percentage complete indication, etc. As another example, standardized data objects identifying risks may be presented as a list with links to additional information. Other standardized data objects may be displayed in any other variety of ways. In some embodiments, generating the dashboard data may include receiving custom display instructions (e.g., from a “super user” or administer associated with an owner or service provider of the data objects), such as instructions to show or hide particular data, modify the manner in which different types of data are presented, etc.

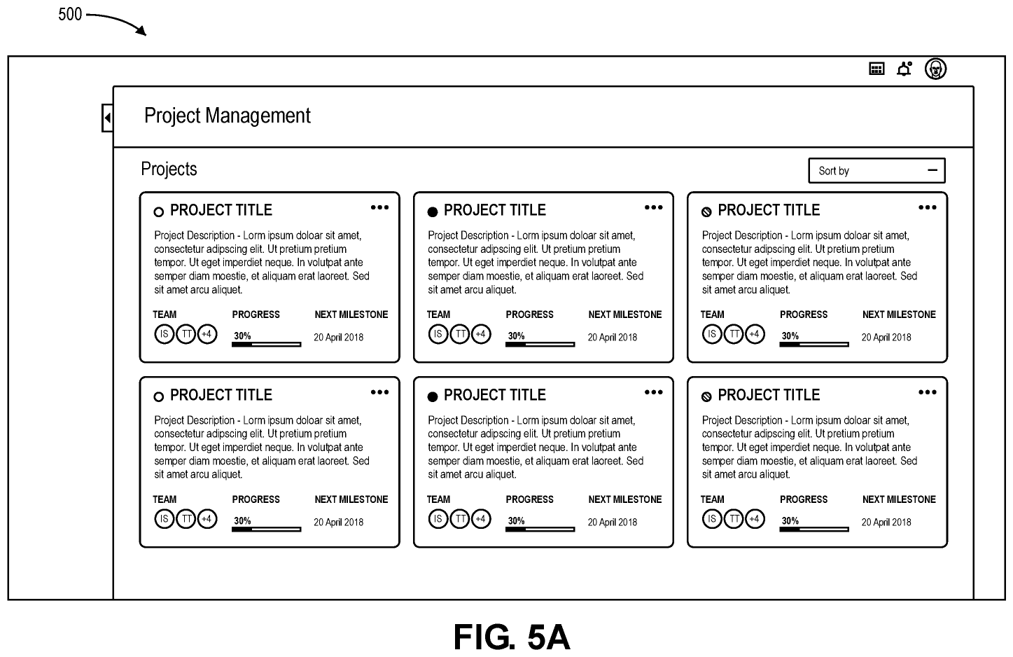

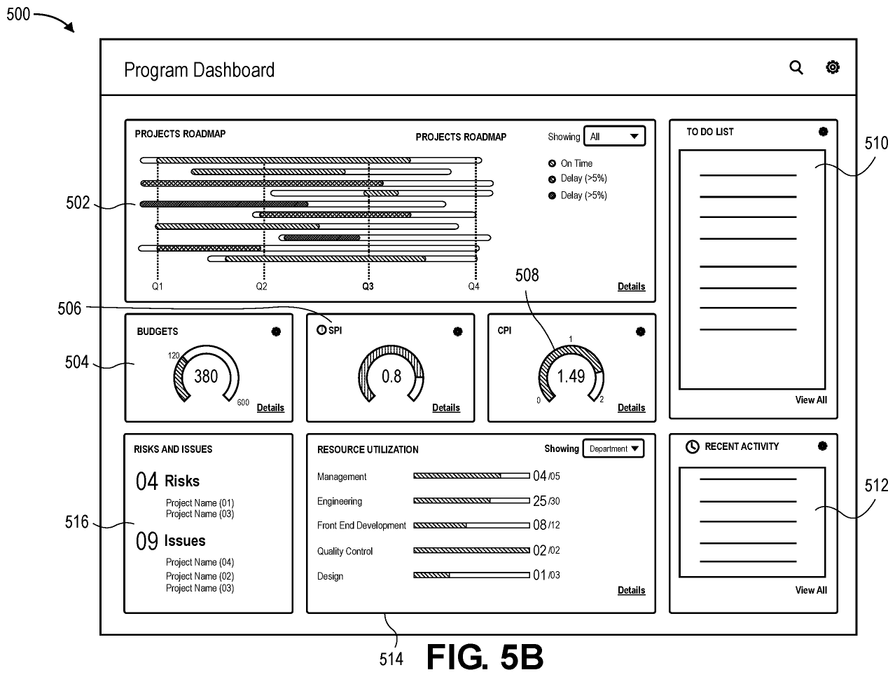

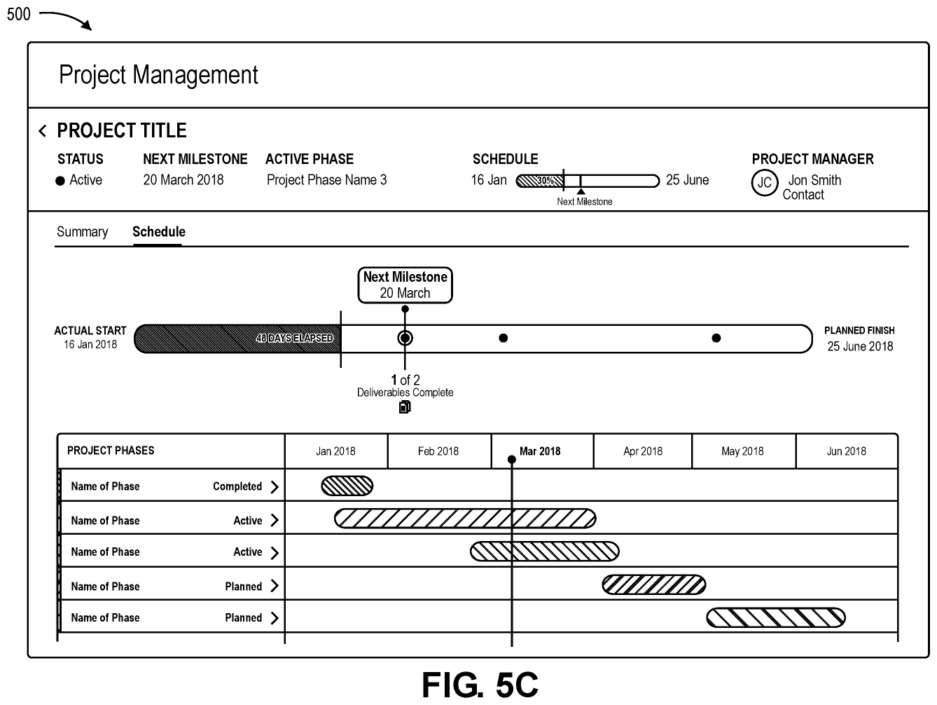

The dashboard data may be provided to the client device 210 for display. Examples of dashboards are shown FIGS. 5A-5C. In this way, a user or client may view project-related data in a standardized and streamlined fashion when the project-related data originates from a service provider's internal systems. Also, as described herein, different types of views may be presented for different types of users (e.g., an “internal view” and a “client view”). As described herein, the dashboard may identify project information, such as, progress, budget, schedules, milestones, risk, issues, etc.

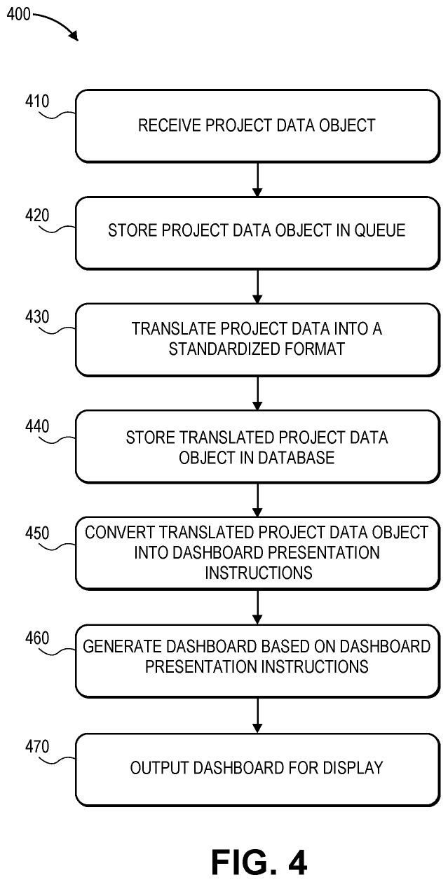

FIG. 4 illustrates an example flowchart of a process of a project tracking application for consolidating oil field project-related data and streamlining the presentation of the project-related data for a user, according to an embodiment. The blocks of FIG. 4 may be implemented in the environment of FIG. 2, for example, and are described using reference numbers of elements depicted in FIG. 2. As noted herein, the flowchart illustrates the architecture, functionality, and operation of possible implementations of systems, methods, and computer program products according to various embodiments of the present disclosure.

The process 400 may include receiving a project data object (as at 410). For example, the project tracking application server 220 may receive a project data object from one or more data sources 230. As described herein, the project tracking application server 220 may obtain the project data object for a particular project on a push or pull basis and may implement any variety of syncing rules and/or syncing logic to obtain the project data object (e.g., on a recurring schedule, when new changes are made and new data objects are generated, etc.). In some embodiments, the project data object may include information identifying a project (e.g., a project related to oil/gas exploration and/or recovery). Additionally, or alternatively, the project data object may contain information pertaining to or project status information and may originate from an internal service provider's project tracker system. For example, a project data object may include project-related information related to task/milestone completion status, budget information, schedule information, project risk/issues information, resource utilization, upcoming project tasks, etc.

The process 400 also may include storing the project data object in a queue (as at 420). For example, the project tracking application server 220 may store the project data object in a queue (e.g., queue 222) as described herein. In some embodiments, the project data object may be stored in an original or unmodified format to maintain the integrity of the original source data.

The process 400 further may include translating the project data object into a standardized format (as at 430). For example, the project tracking application server 220 may translate the project data object into a standardized format using the adapter/converter 224. More specifically, the adapter/converter 224 may analyze a data object, identify project-related information from the data object, and convert the project-related information into a standardized format. In this way, the translated project data object may contain project-related information in a standardized format such that the project-related information may be presented in a dashboard, as discussed in greater detail herein.

The process 400 also may include storing the translated project data object in a database (as at 440). For example, the project tracking application server 220 may store the translated project data into a database (e.g., the database 226). The process 400 further may include converting the translated project data object into dashboard presentation instructions (as at 450). For example, the project tracking application server 220 may convert the translated project data object into dashboard presentation instructions. In some embodiments, converting the translated or standardized data objects into dashboard presentation instructions may involve determining the manner in which the project-related information, contained within the standardized project data objects, are to be presented in the dashboard (e.g., based on the payload within the standardized data objects containing the project-related information). In some embodiments, the dashboard presentation instructions may define a type of widget within which to display the project-related information (e.g., a Gantt chart widget, a pie chart widget, a dial or meter widget, etc.). Additionally, or alternatively, the dashboard presentation instructions may define a location in the dashboard at which to display the project-related information. Additionally, or alternatively, the dashboard presentation instructions may define a color or format of display of the project-related information.

As an illustrative example, standardized data objects containing project-related data identifying milestone status may be presented as widgets in the form of a Gantt chart, a pie chart with a percentage complete indication, etc. As another example, standardized data objects identifying risks may be presented as a list with links to additional information. As described herein, the dashboard presentation instructions may be customized based on user preferences and/or viewing permissions. For example, a user may use the client device 210 to access the project tracker application and provide the project tracking application server 220 with login credentials. Based on receiving the login credentials, the project tracking application server 220 may identify the user's viewing preferences and/or viewing permissions to convert the translated project data object into personalized dashboard presentation instructions. For example, as described herein, an administer may provide input defining the user's viewing permissions, and the user may provide input defining the user's viewing preferences.

The process 400 also may include generating a dashboard based on the dashboard presentation instructions (as at 460). For example, the project tracking application server 220 may generate the dashboard based on the dashboard presentation instructions (e.g., from 450). In some embodiments, the project tracking application server 220 may generate a dashboard that graphically presents a personalized/customized view of the standardized project-related date contained in the translated project data object.

The process 400 also may include outputting the dashboard for display (as at 470). For example, the project tracking application server 220 may output the dashboard for display via the client device 210. In some embodiments, the project tracking application server 220 may output the dashboard based on receiving a request for a dashboard from a user via the client device 210. For example, the user may use the project tracker application to provide login credentials to the project tracking application server 220. Based on receiving the login credentials, the project tracking application server 220 may identify the user, and provide the dashboard to display to the user via the client device 210.

In some embodiments, the process 400 may be repeated to obtain, store, and translate multiple project data objects for one or more oil/gas related projects as the project data objects are received over time and from different data sources 230. In this way, additional project data objects may be received, processed, consolidated, and displayed in a single location, and the dashboard may be updated as new project information is available.

FIGS. 5A-5C illustrate example views of project dashboards presented by the project tracker application, according to an embodiment. As shown in FIG. 5A, the project dashboard 500 may include projects overview page that presents basic overview information for one or more projects in which the user is assigned (e.g., projects in which the user is designated as part of a project team). In some embodiments, the projects overview page may include, for example, project name, project description, progress complete, next milestone date, team information, etc. In some embodiments, the display of projects in the projects overview interface may be ordered/sorted, for example, by project name, project progress, project milestone as well as by ascending/descending order. In some embodiments, the projects overview interface may present both active and/or completed/inactive projects.

Referring to FIG. 5B, the dashboard 500 may further include one or more widgets, relating to project progress, budget metrics, cost metrics, schedule metrics, or the like. For example, the dashboard 500 may include a project roadmap widget 502, a budgets widget 504, a schedule performance index (SPI) widget 506, a cost performance index (CPI) widget 508, a to do list widget 510, a recent activities widget 512, a resource utilization widget 514, and a risk/issues widget 516. In some embodiments, the information presented in the widgets shown in FIG. 5B may be based on the project-related information that is contained in data objects received from a data source 230 associated with a project. That is, the project tracking application server 220 may translate the data objects into a standardized format, and use user preferences and user permissions data to convert the translated data objects into dashboard presentation instructions. For example, the dashboard presentation instructions may include instructions to present the project-related information, contained within the data objects, within the widgets 502-514. Further, the dashboard presentation instructions may specify the types of widgets, the format of the widgets, the colors of the widgets, etc. for presenting the project-related data.

Referring to FIG. 5C, the dashboard 500 may include an interface for displaying project progress. For example, the dashboard 500 may display a Gantt chart of the progress of different project phases, as well as overall project status and milestone points. In some embodiments, project phases may be detailed in an expandable Gantt chart showing the activities within each phase, percentage of each activity complete, and resources assigned to the phase. In some embodiments, the dashboard 500 may identify next milestone dates, project phase name, and project manager information.

In some embodiments, the dashboard may also include a team management widget that allows the super user to manage team members by adding or removing both internal and external users, e.g., based on user identification. The dashboard may further include a summary page which may incorporate a traffic light system to provide an overview of key attributes of a project, such as overall health, resource, schedule, scope, quality, etc. In some embodiments, the dashboard may provide text fields detailing problem statements and corrective actions for each attribute in the summary page. In some embodiments, traffic lights and text may be edited by a super user and are visible to all users assigned to the project team. In some embodiments, the dashboard may also include a schedule page identifying a timeline detailing project milestones and deliverable for both completed project phases and upcoming project phases. The dashboard may present the actual start and planned finish together with days elapsed, the complete date and the next milestone. In some embodiments, the dashboard may further include a risks/issues page that provides a risk/issues summary displaying a traffic light system to represent high, medium and low risks. In some embodiments, the risks may be detailed by date, ID, description, category, type, priority, status and/or action. A filter may be provided to allow users to view either open, or closed risks and for internal users to view internal risks. In some embodiments, the super user may choose to present or hide a risk to the client.

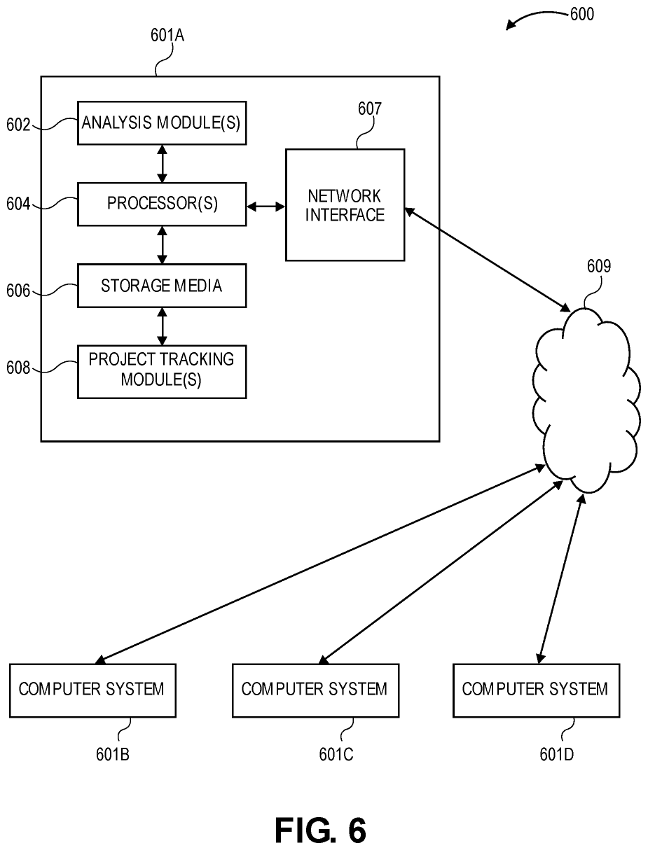

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more project tracking module(s) 608. In the example of computing system 600, computer system 601A includes the project tracking module 608. In some embodiments, a single project tracking module 608 may be used to perform some aspects of one or more embodiments of the methods disclosed herein. In other embodiments, a plurality of project tracking modules 608 may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

What is claimed is:

1. A method comprising:
receiving a plurality of project data objects containing project-related data for one or more oil/gas projects, wherein the plurality of project data objects are in different formats;
storing the plurality of project data objects in a queue;
translating the plurality of project data objects into standardized formats to form translated project data objects containing the project-related data in a standardized format;
generating a dashboard based on the translated project data objects; and
outputting the dashboard for display to a user.

2. The method of claim 1, wherein the generating the dashboard comprises converting the translated project data objects into dashboard presentation instructions.

3. The method of claim 2, wherein the dashboard presentation instructions include at least one selected from the group consisting of:
instructions defining a type of widget within which to display the project-related information;
instructions defining a location in the dashboard at which to display the project-related information; and
instructions defining a color or format of display of the project-related information.

4. The method of claim 2, wherein the converting the translated project data objects is based on user preferences or data viewing permissions.

5. The method of claim 1, further comprising:
receiving login credentials; and
identifying a user based on the login credentials, wherein the generating the dashboard comprises generating a personalized dashboard based on the identifying the user, and the outputting the dashboard comprises presenting the personalized dashboard.

6. The method of claim 1, wherein the dashboard includes at least one selected from the group consisting of:
a project summary page identifying one or more projects associated with a particular user;
a Gantt chart; and
a dial identifying program budget, cost, or scheduling metrics.

7. The method of claim 1, wherein the plurality of data objects originate from one or more internal project tracking systems associated with one or more service providers.

8. A computing system, comprising:
one or more processors; and
a memory system comprising one or more non-transitory computer-readable media storing instructions that, when executed by at least one of the one or more processors, cause the computing system to perform operations, the operations comprising:
receiving a plurality of project data objects containing project-related data for one or more oil/gas projects, wherein the plurality of project data objects are in different formats;
storing the plurality of project data objects in a queue;
translating the plurality of project data objects into standardized formats to form translated project data objects containing the project-related data in a standardized format;
generating a dashboard based on the translated project data objects; and
outputting the dashboard for display to a user.

9. The system of claim 8, wherein the generating the dashboard comprises converting the translated project data objects into dashboard presentation instructions.

10. The system of claim 9, wherein the dashboard presentation instructions include at least one selected from the group consisting of:
instructions defining a type of widget within which to display the project-related information;
instructions defining a location in the dashboard at which to display the project-related information;
instructions defining a color or format of display of the project-related information.

11. The system of claim 9, wherein the converting the translated project data objects is based on user preferences or data viewing permissions.

12. The system of claim 8, wherein the operations further:
receiving login credentials; and
identifying a user based on the login credentials, wherein the generating the dashboard comprises generating a personalized dashboard based on the identifying the user, and the outputting the dashboard comprises presenting the personalized dashboard.

13. The system of claim 8, wherein the dashboard includes at least one selected from the group consisting of:
a project summary page identifying one or more projects associated with a particular user;
a Gantt chart; and
a dial identifying program budget, cost, or scheduling metrics.

14. The system of claim 8, wherein the plurality of data objects originate from one or more internal project tracking systems associated with one or more service providers.

15. A non-transitory computer-readable medium storing instructions that, when executed by one or more processors of a computing system, cause the computing system to perform operations, the operations comprising:
receiving a plurality of project data objects containing project-related data for one or more oil/gas projects, wherein the plurality of project data objects are in different formats;
storing the plurality of project data objects in a queue;
translating the plurality of project data objects into standardized formats to form translated project data objects containing the project-related data in a standardized format;
generating a dashboard based on the translated project data objects; and
outputting the dashboard for display to a user.

16. The computer-readable medium of claim 15, wherein the generating the dashboard comprises converting the translated project data objects into dashboard presentation instructions.

17. The computer-readable medium of claim 16, wherein the dashboard presentation instructions include at least one selected from the group consisting of:
instructions defining a type of widget within which to display the project-related information;
instructions defining a location in the dashboard at which to display the project-related information;
instructions defining a color or format of display of the project-related information.

18. The computer-readable medium of claim 16, wherein the converting the translated project data objects is based on user preferences or data viewing permissions.

19. The computer-readable medium of claim 15, wherein the operations further:
receiving login credentials; and
identifying a user based on the login credentials, wherein the generating the dashboard comprises generating a personalized dashboard based on the identifying the user, and the outputting the dashboard comprises presenting the personalized dashboard.

20. The computer-readable medium of claim 15, wherein the plurality of data objects originate from one or more internal project tracking systems associated with one or more service providers.
